(19) United States
(12) Patent Application Publication
(10) Pub. No.: US 2025/0048435 A1
(43) Pub. Date: Feb. 6, 2025

(54) WAKE UP SIGNAL FOR UPLINK TRANSMISSION

(71) Applicant: LENOVO (BEIJING) LIMITED, BEIJING (CN)

(72) Inventors: ZHI YAN, BEIJING (CN); HONGMEI LIU, BEIJING (CN); YUANTAO ZHANG, BEIJING (CN); YINGYING LI, BEIJING (CN); HAIMING WANG, BEIJING (CN)

(21) Appl. No.: 18/718,399

(22) PCT Filed: Dec. 10, 2021
(86) PCT No.: PCT/CN2021/137008

§ 371 Date: Jun. 10, 2024

(51) Int. Cl. H04W 74/0833; H04W 52/02; H04W 72/0453

(52) U.S. Cl. CPC H04W 74/0833; H04W 52/0235; H04W 72/0453

(57) ABSTRACT

Methods and apparatuses for wake up signal for uplink transmission are disclosed. A method at a UE comprises: receiving PRACH configuration, where one or multiple ROs are in a PRACH configuration period; and transmitting at least a WUS (wake up signal) within a wake, the WUS transmitted at the first or first several ROs within the wake-up period or at a resource in front of RO(s) within the wake-up period.

### FIELD

The subject matter disclosed herein generally relates to wireless communications, and more particularly relates to methods and apparatuses for wake up signal (WUS) for uplink transmission.

### BACKGROUND

The following abbreviations are herewith defined, at least some of which are referred to within the following description: New Radio (NR), Long Term Evolution (LTE), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), wake up signal (WUS), Technical Specification (TS), System Frame Number (SFN), Random Access Channel (RACH), Physical Random Access Channel (PRACH), RACH Occasion (RO), System Information Block (SIB), Physical Broadcast Channel (PBCH), Synchronization Signal (SS), SS/PBCH (SSB, Synchronization Signal Block), paging occasion (PO), Narrow Band Internet of Things (NB-IoT), Demodulation Reference Signal (DMRS), Physical Uplink Shared Channel (PUSCH), Physical Uplink Control Channel (PUCCH), Orthogonal Cover Code (OCC), System Frame Number (SFN).

Physical Random Access Channel (PRACH) has very important functionality especially in LTE and NR. The main purpose of PRACH can achieve uplink synchronization between UE and gNB and obtain the resource for message 3 (e.g., RRC Connection Request). When NR is operating in beamforming mode, UE needs to detect and select a best beam for PRACH process. For random access configuration, NR random access configuration is the parameter that determines when (i.e., which radio frame and which subframe) UE is allowed to transmit PRACH preamble and what kind of preamble format it should transmit. In the following description, if appropriate, RACH has the same meaning as PRACH.

NR random access configuration is specified in TS38.211 v15.5.0, Table 6.3.3.2-2, a part of which is excerpted, as illustrated in FIG. 1(a).

For example, when PRACH Configuration Index=0, x is 16 and y is 1. So, UE is allowed to transmit PRACH in every radio frame n_SFN meeting n_SFN mod 16=1 (e.g. SFN=1, 17, 33, . . . ). Subframe number is set to 1. It means that UE can transmit PRACH at the subframe 1 within the determined radio frames (e.g. SFN=1, 17, 33, . . . ).

FIG. 1(b) illustrates another example of PRACH occasion (or RACH occasion, abbreviated as “RO”) when PRACH Configuration Index=19. x is 1 and y is 0. So, UE is allowed to transmit PRACH in every radio frame n_SFN meeting n_SFN mod 1=0 (i.e. SFN=0, 1, 2, 3, . . . ). Subframe number is set to 1 and 6. It means that UE can transmit PRACH at the subframe 1 and subframe 6 within each radio frame.

RO is an area specified in time domain and frequency domain that is available for the base station's reception of PRACH preamble sent from UE(s). In LTE, there is only one RO specified by RRC message SIB2 for all possible PRACH preambles. So, the base station is required to monitor configured RO even there is no potential UE sending PRACH, which will lead to network energy waste, especially for rural area. For ease of discussion, in the following description, the base station can be represented by gNB, no matter in scenario of LTE o NR.

In NR, the synchronization signal SS/PBCH (SSB) is associated with different beams. UE selects a certain beam (i.e. a certain SSB) and sends PRACH using the selected beam (i.e. the selected SSB). In order for the gNB to figure out which beam UE has selected, 3GPP defines a specific mapping between SSB and RO. The mapping between SSB and RO is defined by two RRC parameters: msg1-FDM and ssb-perRACH-OccasionAndCB-PreamblesPerSSB.

msg1-FDM specifies how many ROs are allocated in frequency domain (at the same location in time domain).

ssb-perRACH-OccasionAndCB-PreamblesPerSSB specifies how many SSBs can be mapped to one RO and how many preamble index (indices) can be mapped to single SSB. The overall mapping logic, that is described in TS38.213 8.1, is: First, in increasing order of preamble indices within a single PRACH occasion; Second, in increasing order of frequency resource indices for frequency multiplexed PRACH occasions; Third, in increasing order of time resource indices for time multiplexed PRACH occasions within a PRACH slot; and Fourth, in increasing order of indices for PRACH slots.

FIGS. 2(a) and 2(b) illustrate two examples of mapping between SSB and RO. FIG. 2(a) illustrates an example in which msg1-FDM=1 and ssb-perRACH-OccasionAndCB-PreamblesPerSSB=1. FIG. 2(b) illustrates an example in which msg1-FDM=2 and ssb-perRACH-OccasionAndCB-PreamblesPerSSB=1.

Associated period is introduced to define a time duration for mapping SSB blocks to ROs based on a PRACH configuration period. The associated period starts from frame 0 and all SSB blocks should be mapped to RO at least once within the associated period. The associated period is configured as one or multiple PRACH configuration periods. As shown in FIG. 3, which illustrates the mapping between PRACH configuration period and SSB block to PRACH occasion associated period specified in TS38.211 Table 8.1-1, depending on the time length of the PRACH configuration period (e.g. 10, 20, 40, 80 and 160, in unit of msec), the associated period can be 1 or 2 or 4 or 8 or 16 number(s) of PRACH configuration period.

For example, as shown in FIG. 4, the PRACH configuration period is 10 ms; the associated period is 2 (i.e. associated period=2*10 ms=20 ms); msg1-FDM=4, ssb-perRACH-OccasionAndCB-PreamblesPerSSB=½ (i.e. ½ SSB is mapped to one RO, which is equivalent to: one SSB (e.g. SSB1) is mapped to two ROs).

This invention targets enhancing the PRACH configuration for saving energy at the base station (e.g. gNB).

### BRIEF SUMMARY

Methods and apparatuses for wake up signal (WUS) for uplink transmission (e.g. WUS in PRACH) are disclosed.

In one embodiment, a method at an UE comprises receiving PRACH configuration, wherein one or multiple ROs are in a PRACH configuration period; and transmitting at least a WUS (wake up signal) within a wake-up period, the WUS is transmitted at the first or first several ROs within the wake-up period, or at a resource in front of RO(s) within the wake-up period. The wake-up period may be one or multiple of the PRACH configuration period.

In one embodiment, the WUS is transmitted when random access is expected to be performed in ROs following to the resource at which the WUS is transmitted.

In another embodiment, the ROs within the wake-up period are associated with an SSB within an associated period in which the SSB and the ROs are associated, wherein the associated period is one or multiple of the PRACH configuration period, and the first or first several ROs within the wake-up period are first or first several ROs associated with the SSB in time domain. In particular, the first or first several ROs within the wake-up period are one or more ROs associated with the SSB having the highest or lowest frequency band(s) in frequency domain. In some embodiment, the wake-up period is a first number of the associated period. The first number may be configured by higher layer signaling.

In still another embodiment, the WUS is selected from a WUS set, where the WUS set is a subset of a preamble set in PRACH procedure. In another embodiment, the WUS is selected from a WUS set associated with a UE group including the UE, where the WUS set associated with the UE group is a subset of preamble set in PRACH procedure.

In one embodiment, a method at a base unit comprises transmitting PRACH configuration, wherein one or multiple ROs are in a PRACH configuration period; and monitoring a WUS (wake up signal) at the first or first several ROs within the wake-up period, or at a resource in front of RO(s) within the wake-up period. The wake-up period may be one or multiple of the PRACH configuration period. In some embodiment, when the WUS is detected at any of the first or first several ROs within the wake-up period or at the resource in front of RO(s) within the wake-up period, the method further comprises monitoring the following ROs for normal random access.

In another embodiment, a remote unit (UE) comprises; a receiver that receives PRACH configuration, wherein one or multiple ROs are in a PRACH configuration period; and a transmitter that transmits at least a WUS (wake up signal) within a wake-up period, the WUS is transmitted at the first or first several ROs within the wake-up period; or at a resource in front of RO(s) within the wake-up period.

In yet another embodiment, a base unit comprises; a transmitter that transmits PRACH configuration, wherein one or multiple ROs are in a PRACH configuration period; and a processor that monitors a WUS (wake up signal) at the first or first several ROs within the wake-up period: or at a resource in front of RO(s) within the wake-up period.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1(a) illustrates NR random access configuration;

FIG. 1(b) illustrates an example of PRACH occasion when PRACH Configuration Index=19;

FIGS. 2(a) and 2(b) illustrate two examples of mapping between SSB and RO;

FIG. 3 illustrates the mapping between PRACH configuration period and SSB block to PRACH occasion associated period;

FIG. 4 illustrates an example of associated period;

FIG. 5 illustrates an example of the first embodiment;

FIG. 6 illustrates an example of the second embodiment;

FIG. 7 illustrates an example of the third embodiment;

FIG. 8 illustrates an example of the fourth embodiment;

FIG. 9 illustrates an example of the fifth embodiment;

FIG. 10 illustrates an example of the sixth embodiment;

FIG. 11 illustrates an example of WUS and PUSCH transmission;

FIG. 12 is a schematic flow chart diagram illustrating an embodiment of a method;

FIG. 13 is a schematic flow chart diagram illustrating another embodiment of a method;

FIG. 14 is a schematic flow chart diagram illustrating an embodiment of a method;

FIG. 15 is a schematic flow chart diagram illustrating another embodiment of a method; and

FIG. 16 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

As mentioned in the background part, for a legacy PRACH configuration, no matter whether there is potential UE sending PRACH or not, the gNB has to monitor all configured ROs, which would lead to waste of power by the gNB.

This disclosure proposes wake up signal (WUS) for uplink transmission.

WUS was introduced for power saving in NB-IoT technology, wherein the WUS indicates whether there is paging process in a pre-defined paging occasion (PO). The WUS is transmitted from the gNB. When the UE detects the WUS, the UE shall monitor the following PO.

The WUS for uplink transmission proposed in this disclosure is transmitted by the UE.

In the first to the fifth embodiments, the WUS for uplink transmission relate to WUS in PRACH. In particular, the UE sends a WUS in PRACH in RO or before RO to the gNB when the UE expects to have random access within a wake-up period.

According to a first embodiment, UE is configured with a new type of PRACH resource (e.g. PRACH resource for WUS) in addition to legacy PRACH resource in a legacy PRACH configuration. A detailed description of the first embodiment is made with reference to FIG. 5.

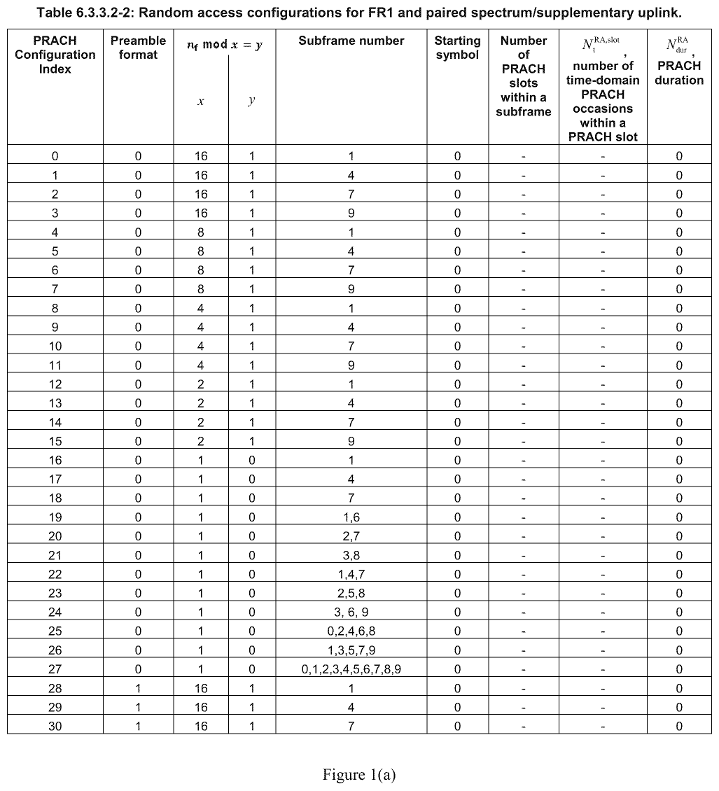

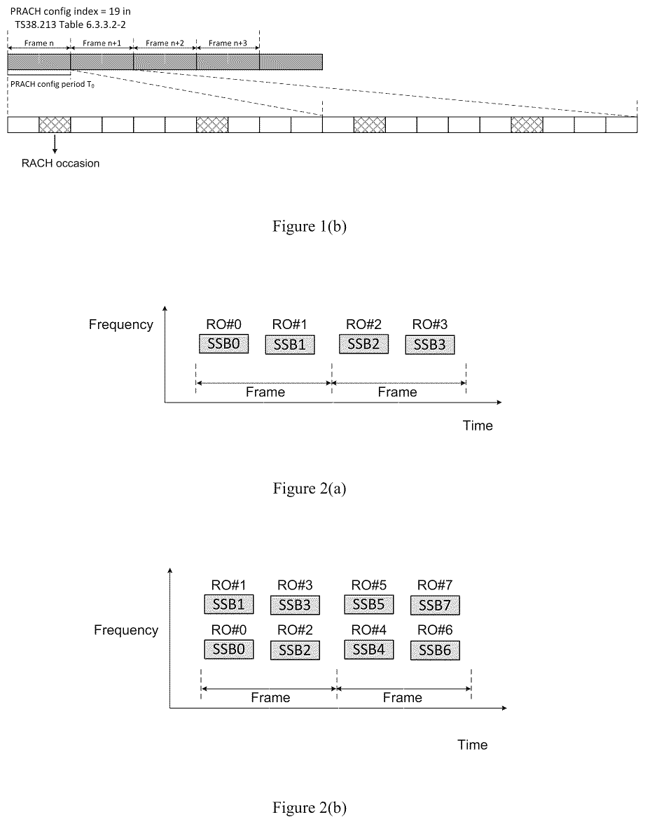

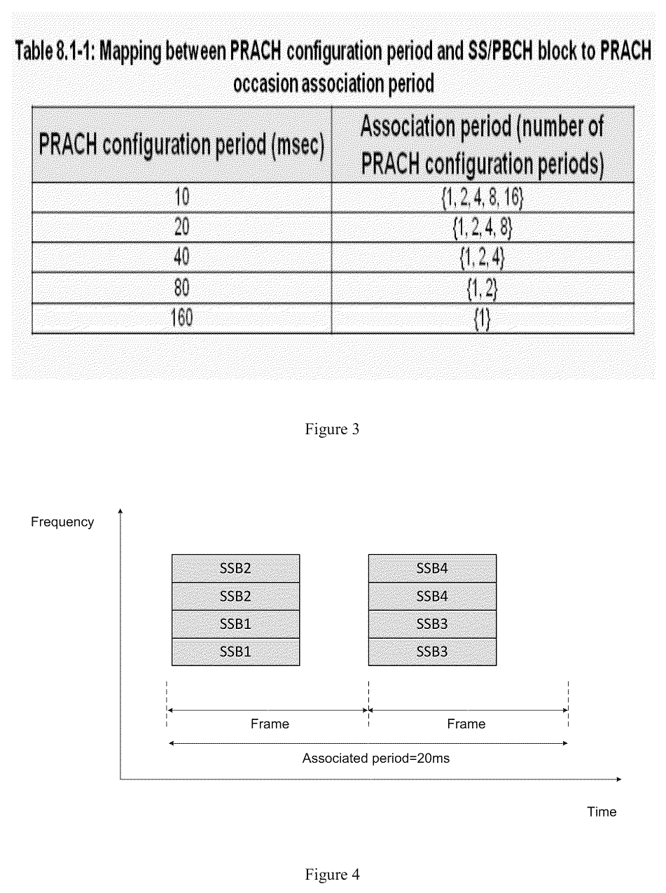

T₁ is wake-up period of the UE. T₁ is M times of T₀ (i.e., T₁=M*T₀), where M is an integer that is 1 or more. T₀ is PRACH configuration period. The PRACH configuration period T₀ is the same as FIG. 1(b), where the PRACH configuration index is 19 in TS38.213 Table 6.3.3.2-2 (see FIGS. 1(a) and 1(b)). As can be seen from FIG. 5, T₁=4*T₀ while the time length of each T₀ is one frame (e.g. 10 ms). ROs are in subframes 1 and 6 of each frame (e.g. frames n to n+3 in the wake-up period). FIG. 5 only illustrates the ROs in the first two T₀ (i.e. frame n and frame n+1) within the wake-up period T₁. It is obvious that, in each of the last two T₀ (i.e. frame n+2 and frame n+3) within the wake-up period T₁, there are also two ROs. As a whole, in the example of FIG. 5, there are four PRACH configuration periods (each with a time length of one frame) in the wake-up period, and there are 2 ROs in each PRACH configuration period.

According to the first embodiment, the first RO or first several ROs within every T₁ time duration is/are used for WUS in PRACH (Note that in the following description of the first to the fifth embodiments, “WUS in PRACH” can be abbreviated as “WUS”), while the remaining ROs within the T₁ time duration are for normal random access. In other words, the new type of PRACH resource (i.e. PRACH resource for WUS) is configured periodically with one or more ROs for WUS followed by one or more ROs for normal random access within the wake-up period (T₁).

In the example of FIG. 5, the first RO is for WUS, while the remaining ROs are for normal random access. The first RO means the first RO in the wake-up period, and it is the first RO in the first PRACH configuration period in the wake-up period. As can be seen from FIG. 5, the first RO (i.e. the first RO within the wake-up period) is used for WUS, while the remaining 7 ROs are for normal random access.

FIG. 5 shows that only the first one RO is used for WUS. It is possible that the first several ROs can be used for WUS. For example, the first two ROs can be used for WUS. It is apparent that the number of ROs used for WUS should be smaller than the whole number of ROs within the wake-up period. The number of ROs used for WUS can be configured by higher layer parameter(s).

In the RO(s) for WUS, the UE performs WUS transmission if the UE expects to have random access within the wake-up period (T₁). In the following ROs (i.e. the ROs not used for WUS) within the wake-up period, legacy PRACH access procedure can be performed. So, its detailed description is omitted. Needless to say, if the UE does not expect to have random access within the wake-up period, no WUS transmission is performed in the RO(s) for WUS.

The gNB monitors the RO(s) for WUS. It means that the gNB tries to receive WUS in the RO(s) for WUS. When the gNB detects WUS in any RO for WUS (i.e., the gNB receives WUS in any RO for WUS), the gNB shall monitor the following ROs for normal random access within the wake-up period (T₁). Otherwise (the gNB does not detect WUS in any of the RO(s) for WUS (i.e. the gNB does not receive WUS in any of the RO(s) for WUS)), the gNB is not required to monitor the following RO(s) within the wake-up period of T₁. Accordingly, the gNB can achieve the benefit of skipping monitoring the remaining ROs within the wake-up period. Incidentally, the term “monitor a resource (such as RO(s) for WUS)” used hereinafter means “tries to receive a signal (such as WUS) in a resource (such as RO(s) for WUS). If there is the signal in the resource (i.e. the signal is detected), “monitor the resource” is equivalent to “receive the signal in the resource”. If there is no the signal in the resource (i.e. the signal is not detected), the signal is not actually received.

In the RO(s) for WUS, UE is expected to perform PRACH as legacy procedure. The WUS on corresponding transmission resource follows the preamble on PRACH configuration (e.g., preamble configuration). If there are two or more ROs for WUS, the UE can randomly select one of the two or more ROs for WUS to perform PRACH.

In the RO for WUS, the gNB is expected to perform the reception of WUS based on PRACH procedure and/or based on energy or power sensing. Energy or power sensing can be implemented by gNB. For example, gNB can detect the energy or power of the received signal, or analyze the received signal feature (including signal first order or second order analysis).

In the first embodiment, the first or the first several ROs within every T₁ (wake-up period) time duration are used for WUS, and the remaining ROs within every T₁ (wake-up period) time duration are used for normal random access. According to a second embodiment, all of the ROs within every T₁ (wake-up period) time duration are used for normal random access, while a WUS resource is periodically configured before all of the ROs (or before the first RO) within each wake-up period.

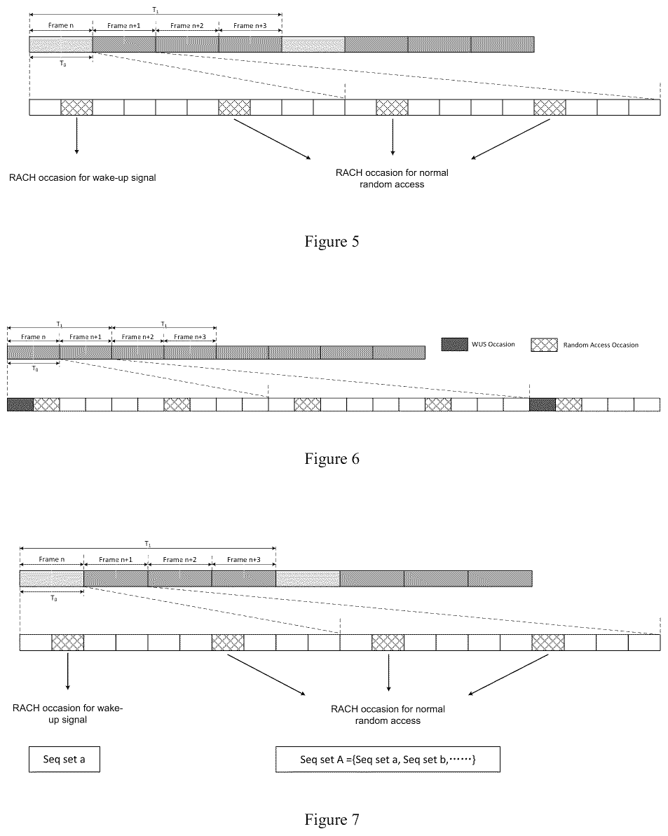

FIG. 6 illustrates an example of the second embodiment, in which T₁ (wake-up period)=2*T₀ (PRACH configuration period). In front of ROs (e.g. all of ROs) within each wake-up period (T₁), a WUS resource is configured. The subframe in which the WUS resource is configured can be referred to as WUS occasion. The WUS occasion in front of ROs within each wake-up period has the same meaning as the WUS occasion in front of the first RO within each wake-up period, since it is apparent if the WUS occasion is in front the first RO, it is definitely in front of all of ROs. Incidentally, it is also possible that a WUS occasion is in front of a particular time point (e.g. an SFN) while ROs within the wake-up period are after the particular time point.

According to the second embodiment, the gNB monitors the WUS occasion. When the gNB detects WUS in the WUS occasion, the gNB shall monitor the following ROs for normal random access within the wake-up period (T₁). Otherwise (the gNB does not detect WUS in the WUS occasion), the gNB is not required to monitor the following RO(s) within the wake-up period of T₁.

According to the first embodiment or the second embodiment, the WUS on corresponding transmission resource follows the preamble on PRACH configuration (e.g., preamble configuration). For example, if there are a total of 64 candidate preambles in preamble configuration, any of the 64 candidate preambles can be used for the WUS in any RO for WUS (for the first embodiment) or in the WUS occasion (for the second embodiment).

According to a third embodiment, the UE is expected to use a restricted set of preambles or restricted frequency resources set in the RO for WUS or in the WUS occasion, so as to suppress interference and reduce network detection complexity. On the other hand, the UE is expected to perform legacy PRACH procedure in other ROs (i.e. ROs not for WUS, or ROs for normal random access) with all available preambles or frequency resource set or beam.

FIG. 7 illustrates an example of the third embodiment. In RO for WUS, the UE is expected to use the preambles contained in “Seq set a” (“Seq” means “sequence”), which is a subset of “Seq set A” composed of e.g. “Seq set a”, “Seq set b”, etc. The UE is expected to use all preambles contained in “Seq set A” in legacy PRACH procedure in other ROs (ROs for normal random access). For example, “Seq set A” may consist of 64 sequences, while “Seq set a” may consist of the first several sequences of “Seq set A” (e.g. first 5 sequences). It means that the sequences that can be used for RO for WUS may be first 5 sequences of the total 64 sequences.

According to a fourth embodiment, in order to further reduce the gNB power consumption, UEs can be divided into S (S>1) groups, e.g. based on different UE IDs. The UEs in different groups are associated with different restricted sets (e.g., restricted sets of preambles or restricted frequency resources sets) for both RO(s) for WUS and ROs for normal random access.

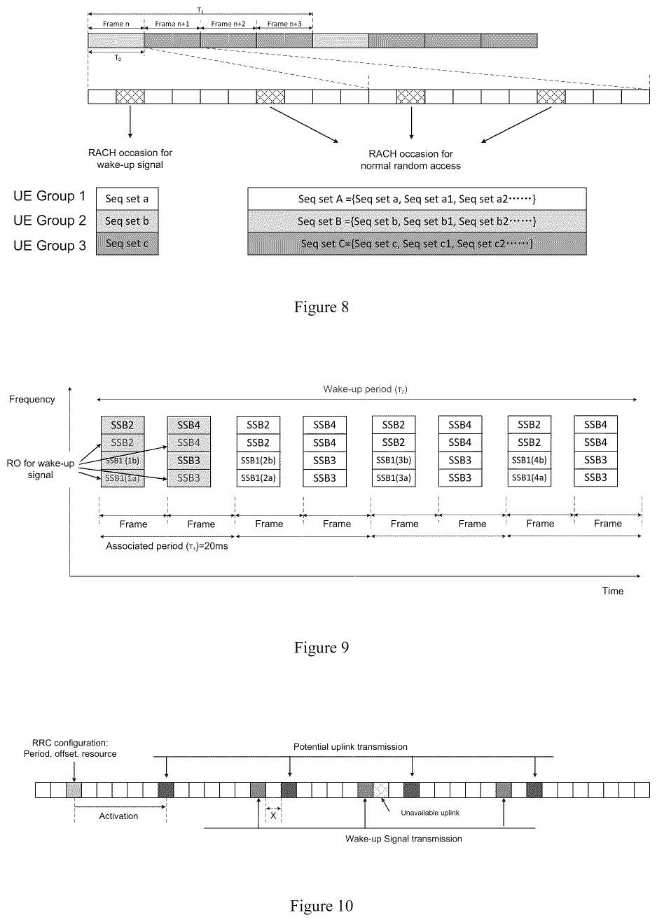

FIG. 8 illustrates an example of the fourth embodiment. UEs are divided into 3 (S=3) groups: UE Group 1; UE Group 2; UE Group 3.

UEs in UE Group 1 are expected to use preambles contained in “Seq set a” (e.g. preamble indices 0-4) for the RO for WUS, while use preambles contained in “Seq set A” (e.g. preamble indices 0-19) composed of e.g. “Seq set a”, “Seq set a1”, “Seq set a2”, etc, for the remaining ROs for normal random access.

UEs in UE Group 2 are expected to use preambles contained in “Seq set b” (e.g. preamble indices 20-24) for the RO for WUS, while use preambles contained in “Seq set B” (e.g. preamble indices 20-39) composed of e.g. “Seq set b”, “Seq set b1”, “Seq set b2”, etc, for the remaining ROs for normal random access.

UEs in UE Group 3 are expected to use preambles contained in “Seq set c” (e.g. preamble indices 40-44) for the RO for WUS, while use preambles contained in “Seq set C” (e.g. preamble indices 40-59) composed of e.g. “Seq set c”, “Seq set c1”, “Seq set c2”, etc, for the remaining ROs for normal random access.

According to a fifth embodiment, in the condition that UE operates in beamforming mode where multiple beams are used, i.e. ROs are associated with different SSBs, for each SSB associated RO within a wake-up period, the first RO or first several ROs is/are RO(s) for WUS. The fifth embodiment is discussed with reference to an example illustrated in FIG. 9.

T₂ is wake-up period of the UE. T₂ is M times of T₃ (i.e., T₂=M*T₃), where M is an integer that is 1 or more, and M can be configured by higher layer signaling. T₃ is an SSB and RO associated period. As mentioned in the background part, the SSB and RO associated period is configured as one or multiple PRACH configuration periods so that all SSBs can be mapped to RO at least once within the SSB and RO associated period. In the example of FIG. 9, within each SSB and RO associated period (indicated as “associated period” in FIG. 9), each SSB (each of SSB1, SSB2, SSB3 and SSB4) is transmitted at least once (e.g. twice in FIG. 9) in each associated period. In FIG. 9, the PRACH configuration period is 10 ms. The associated period is 2 (i.e. associated period=2*PRACH configuration period=2*10 ms=20 ms). msg1-FDM=4. It means that, at the same location in time domain (e.g. one frame in FIG. 9), 4 ROs are allocated in frequency domain. For example, in the first frame, there are 4 ROs in different frequency positions (indicated by “SSB1(1a)”, “SSB1(1b)”, “SSB2”, “SSB2”). ssb-perRACH-OccasionAndCB-PreamblesPerSSB=½. It means that ½ SSB is mapped to one RO (i.e. one SSB is mapped to 2 ROs). For example, SSB1 is mapped to two ROs before SSB2 is mapped to subsequent two ROs.

For each SSB (e.g. each of SSB1, SSB2, SSB3 and SSB4) associated ROs (e.g. the ROs labeled as SSB1(1a), SSB (1b), SSB1 (2a), SSB (2b), SSB1 (3a), SSB (3b), SSB1 (4a), SSB (4b) in FIG. 9), the first RO (e.g. the RO with the lowest frequency in the first associated period) is the RO for WUS for the SSB (e.g. the RO labeled as “SSB1(1a)” pointed by “RO for wake up signal” in FIG. 9 is the RO for WUS for SSB1), while the remaining ROs are the ROs for normal random access for the SSB (e.g., the ROs labeled as SSB (1b), SSB1 (2a), SSB (2b), SSB1 (3a), SSB (3b), SSB1 (4a), SSB (4b) are the ROs for normal random access for SSB1).

Similarly, for SSB2 (or SSB3 or SSB4) associated ROs, the first RO (e.g. the RO with the lowest frequency in the first associated period) is the RO for WUS for SSB2 (or SSB3 or SSB4) (i.e. the RO labeled as SSB2 or SSB3 or SSB4 pointed by “RO for wake up signal”), while the remaining ROs (i.e. all of ROs labeled as SSB2 or SSB3 or SSB4 within the wake-up period, except for the RO labeled as SSB2 or SSB3 or SSB4 pointed by “RO for wake up signal”) are the ROs for normal random access for SSB2 (or SSB3 or SSB4).

Incidentally, it is possible that, for each SSB, the first several ROs (e.g. the two ROs with the lowest or highest frequencies in the first associated period) are the ROs for WUS for the SSB, while the remaining ROs are the ROs for normal random access for the SSB.

When the number of the first several ROs for WUS for one SSB is larger than the total number of ROs for the one SSB in one associated period, the first RO or first several ROs in following associated period(s) will also possibly become the RO(s) for WUS for the one SSB.

As a whole, the ROs for one SSB can be ordered firstly in time domain by associated period and secondly in frequency domain by the lowest or highest frequency band within each associated period. For example, if SSB1 is ordered firstly by associated period and secondly by the lowest frequency band within each associated period, the order of the ROs for SSB1 is SSB1(1a), SSB (1b), SSB1 (2a), SSB (2b), SSB1 (3a), SSB (3b), SSB1 (4a), SSB (4b); while if SSB1 is ordered firstly by associated period and secondly by the highest frequency band within each associated period, the order of the ROs for SSB1 is SSB (1b), SSB1(1a), SSB (2b), SSB1 (2a), SSB (3b), SSB1 (3a), SSB (4b), SSB1 (4a).

For each SSB (e.g. each of SSB1, SSB2, SSB3 and SSB4), the UE may perform WUS transmission in any RO for WUS for the SSB, if the UE is expected to have random access within the wake-up period (T₂) for the SSB.

The gNB monitors the RO(s) for WUS for each SSB. When gNB detects WUS in any RO for WUS for a certain SSB (e.g. the RO for WUS for SSB1), the gNB shall monitor the following ROs for normal random access for the certain SSB (e.g. SSB1) within the wake-up period (T₂). Otherwise (the gNB does not detect WUS in any of the RO(s) for WUS for the certain SSB), the gNB is not required to monitor the following RO(s) for the certain SSB within the wake-up period (T₂).

Alternatively, when gNB detects WUS in any RO for WUS for a certain SSB (e.g. the RO for WUS for SSB1), the UE may monitor the following ROs within the wake-up period (T₂) for normal random access for all SSBs (e.g. SSB1, SSB2, SSB3 and SSB4). Otherwise (the gNB does not detect WUS in any of the RO(s) for WUS for all SSBs), the gNB is not required to monitor the following RO(s) for all SSBs within the wake-up period (T₂).

The above-described first to fifth embodiments are related to WUS in PRACH. A sixth embodiment is related to WUS for configured grant transmission.

According to the sixth embodiment, for configured grant uplink transmission, UE is expected to transmit a WUS (e.g., uplink scheduling request) before the configured grant uplink transmission. The WUS described in the sixth embodiment is not a WUS in PRACH, but a WUS transmitted before the configured grant uplink transmission. The sixth embodiment is described with reference to an example illustrated in FIG. 10.

As illustrated in FIG. 10, the UE is expected to perform WUS transmission each time before the UE transmits data on a configured grant resource (i.e. configured grant uplink resource). The end of WUS transmission is X symbol(s) before the configured grant uplink transmission, where X can be configured by gNB via higher layer signaling or be a fixed value, and X can be a non-negative integer (e.g. 0, 1, 2, . . . ). In FIG. 10, X is configured as 1 symbol.

The gNB monitor the WUS. When the gNB detects the WUS, the gNB shall continue to monitor the uplink data in the configured granted uplink resource on which potential uplink transmission would be performed. Otherwise (when the gNB does not detect the WUS), the gNB is not required to monitor the uplink data in the corresponding granted uplink resource.

According to a variety of the sixth embodiment, the end of WUS transmission is X symbol(s) before every Y uplink transmissions, where X can be configured by gNB. The UE is expected to perform WUS if UE transmits data on any of Y configured grant uplink resources. Y (Y can be a positive integer) can be configured by higher layer signaling. Alternatively, Y can be determined by the WUS. For example, the WUS may be a sequence with different OCC in time or frequency domain. Accordingly, Y can be determined by different OCC values of the WUS sequence. For another example, the WUS may be a sequence with different phase cyclic shift. Accordingly, Y can be determined by different phase cyclic shifts of the WUS sequence. For example, when phase cyclic shift=alpha 1, Y=1; while when phase cyclic shift=alpha 2, Y=2, etc.

According to a further variety of the sixth embodiment, the end of WUS transmission is X symbol(s) before a wake-up period, where X can be configured by gNB. The start of the wake-up period can be configured by a time point (e.g. a SFN and a subframe number). The time length of the wake-up period can be determined by the number of subframes, or by the number (e.g. Y) of uplink transmissions. Y (Y can be a positive integer) can be configured by higher layer signaling or determined by the WUS, as described in the variety of the sixth embodiment.

The gNB monitor the WUS. When the gNB detects the WUS, the gNB shall continue to monitor the subsequent configured granted resource or Y granted resources for uplink data. Otherwise (when the gNB does not detect the WUS), the gNB is not required to detect the subsequent granted resource or Y granted resources for uplink data. The gNB can achieve power energy saving by skipping detection of some configured resource(s).

The WUS is transmitted in the latest uplink symbol no early than X symbol(s) before the uplink transmission. That is to say, the unavailable uplink symbol(s) are not counted in determining the number of X symbol(s).

The WUS transmitted before the configured grant uplink transmission can be used as an RS for channel estimation. For example, the WUS is QCLed with DMRS. The WUS can be similar to front-loaded DMRS (the DMRS can follow the PUSCH corresponding additional DMRS generation method). Alternatively, the WUS can be similar to sequence based PUCCH format 0 with repetition and/or extension in time domain and/or frequency domain, since the WUS needs more resources than PUCCH format 0 with only 1 PRB in frequency domain and 1 or 2 symbols in time domain.

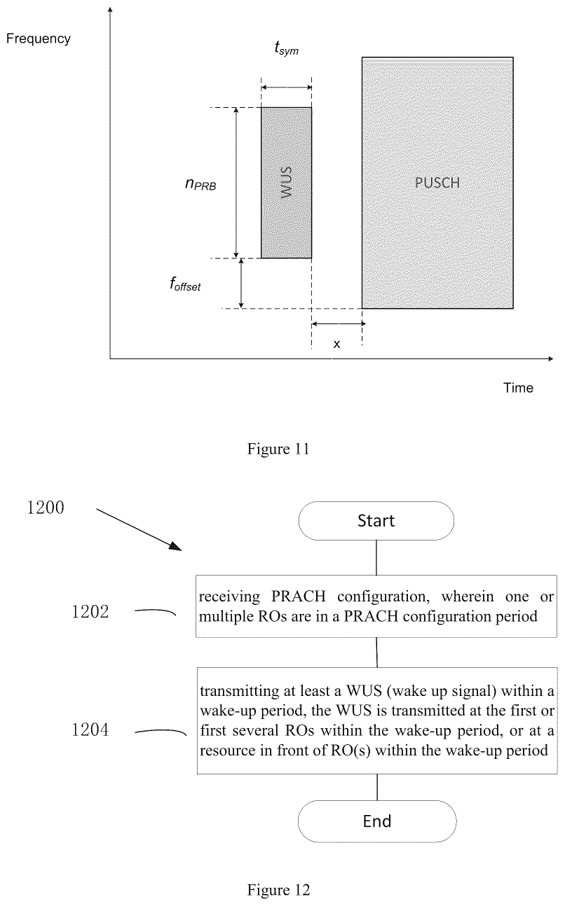

The frequency position of the WUS can be configured by gNB. For example, the frequency position is determined by the offset value of the lowest or the highest frequency of the uplink transmission. For example, as shown in FIG. 11, the lower frequency of the WUS can be f_{offset} relative to the lowest frequency of the PUSCH transmission.

The time duration (t_{sym}) and the frequency bandwidth (N_{PRB}) of the WUS can be configured by gNB. For example, each of the time duration (t_{sym}) and the frequency bandwidth (N_{PRB}) of the WUS can be scaled from the uplink resource (i.e. PUSCH transmission). For example, the time duration (t_{sym}) of the WUS is a fraction of the time length of the configured grant PUSCH transmission; and the frequency bandwidth (N_{PRB}) of the WUS is also a fraction of the frequency band of the configured grant PUSCH transmission.

FIG. 12 is a schematic flow chart diagram illustrating an embodiment of a method 1200 according to the present application. In some embodiments, the method 1200 is performed by an apparatus, such as a remote unit (UE). In certain embodiments, the method 1200 may be performed by a processor executing program code, for example, a microcontroller, a microprocessor, a CPU, a GPU, an auxiliary processing unit, a FPGA, or the like.

The method 1200 may comprise 1202 receiving PRACH configuration, wherein one or multiple ROs are in a PRACH configuration period; and 1204 transmitting at least a WUS (wake up signal) within a wake-up period, the WUS is transmitted at the first or first several ROs within the wake-up period, or at a resource in front of RO(s) within the wake-up period. The wake-up period may be one or multiple of the PRACH configuration period.

In some embodiment, the WUS is transmitted when random access is expected to be performed in ROs following to the resource at which the WUS is transmitted.

In one embodiment, the ROs within the wake-up period are associated with an SSB within an associated period in which the SSB and the ROs are associated, wherein the associated period is one or multiple of the PRACH configuration period, and the first or first several ROs within the wake-up period are first or first several ROs associated with the SSB in time domain. In particular, the first or first several ROs within the wake-up period are one or more ROs associated with the SSB having the highest or lowest frequency band(s) in frequency domain. In some embodiment, the wake-up period is a first number of the associated period. The first number may be configured by higher layer signaling.

In some embodiment, the WUS is selected from a WUS set, where the WUS set is a subset of a preamble set in PRACH procedure. In other embodiment, the WUS is selected from a WUS set associated with a UE group including the UE, where the WUS set associated with the UE group is a subset of preamble set in PRACH procedure.

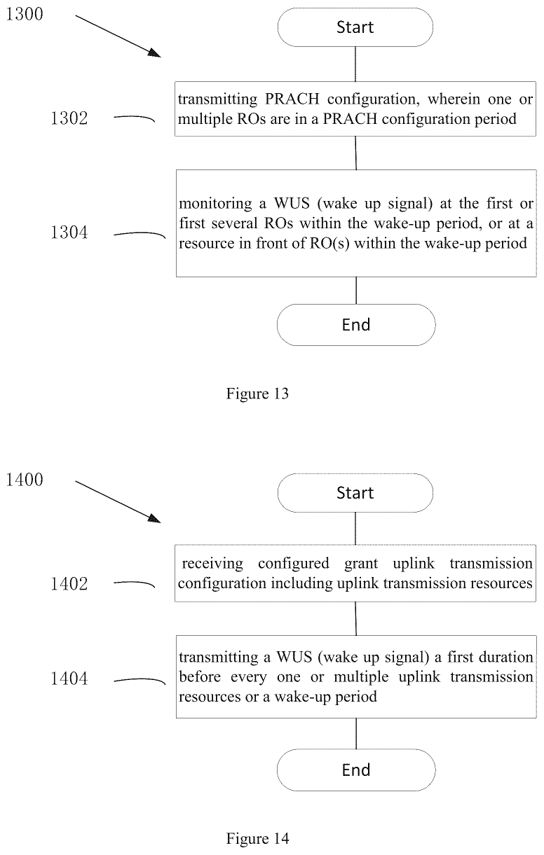

FIG. 13 is a schematic flow chart diagram illustrating a further embodiment of a method 1300 according to the present application. In some embodiments, the method 1300 is performed by an apparatus, such as a base unit. In certain embodiments, the method 1300 may be performed by a processor executing program code, for example, a microcontroller, a microprocessor, a CPU, a GPU, an auxiliary processing unit, a FPGA, or the like.

The method 1300 may comprise 1302 transmitting PRACH configuration, wherein one or multiple ROs are in a PRACH configuration period; and 1304 monitoring a WUS (wake up signal) at the first or first several ROs within the wake-up period, or at a resource in front of RO(s) within the wake-up period. The wake-up period may be one or multiple of the PRACH configuration period.

In some embodiment, when the WUS is detected at any of the first or first several ROs within the wake-up period or at the resource in front of RO(s) within the wake-up period, the method further comprises monitoring the following ROs for normal random access.

In one embodiment, the ROs within the wake-up period are associated with an SSB within an associated period in which the SSB and the ROs are associated, wherein the associated period is one or multiple of the PRACH configuration period, and the first or first several ROs within the wake-up period are first or first several ROs associated with the SSB in time domain. In particular, the first or first several ROs within the wake-up period are one or more ROs associated with the SSB having the highest or lowest frequency band(s) in frequency domain. In some embodiment, the wake-up period is a first number of the associated period. The first number may be configured by higher layer signaling.

In some embodiment, the WUS is selected from a WUS set, where the WUS set is a subset of a preamble set in PRACH procedure. In other embodiment, the WUS is selected from a WUS set associated with a UE group including the UE, where the WUS set associated with the UE group is a subset of preamble set in PRACH procedure.

FIG. 14 is a schematic flow chart diagram illustrating an embodiment of a method 1400 according to the present application. In some embodiments, the method 1400 is performed by an apparatus, such as a remote unit (UE). In certain embodiments, the method 1400 may be performed by a processor executing program code, for example, a microcontroller, a microprocessor, a CPU, a GPU, an auxiliary processing unit, a FPGA, or the like.

The method 1400 may comprise 1402 receiving configured grant uplink transmission configuration including uplink transmission resources; and 1404 transmitting a WUS (wake up signal) a first duration before every one or multiple uplink transmission resources or a wake-up period. The first duration may be configured by higher layer signaling.

In some embodiment, the WUS is transmitted in the latest uplink resource no early than the first duration before every one or multiple uplink transmission resources or start of the wake-up period.

In one embodiment, the frequency position of the WUS is determined by a frequency offset to the uplink transmission resources. In another embodiment, the time duration and/or the frequency band of the WUS is scaled from the uplink transmission resource.

In some embodiment, the number of the uplink transmission resources is determined by the WUS. In some other embodiment, the WUS is derived from an RS of the uplink transmission in the uplink transmission resource.

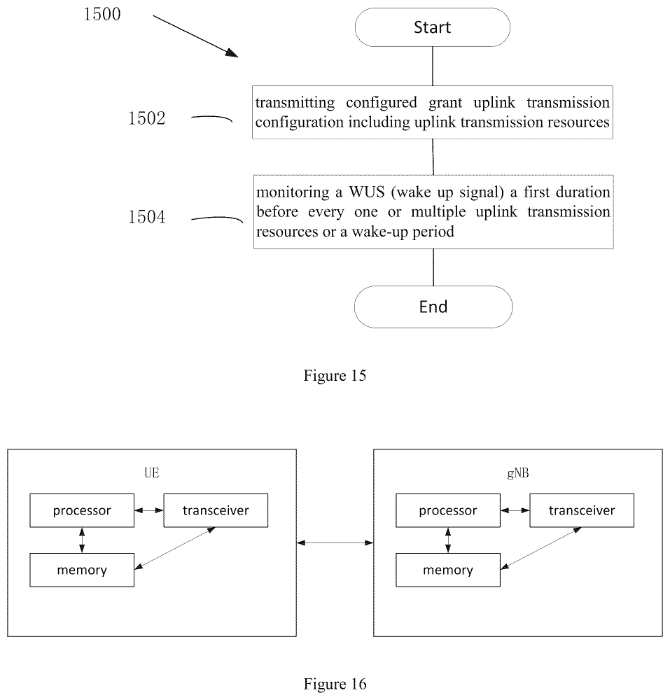

FIG. 15 is a schematic flow chart diagram illustrating a further embodiment of a method 1500 according to the present application. In some embodiments, the method 1500 is performed by an apparatus, such as a base unit. In certain embodiments, the method 1500 may be performed by a processor executing program code, for example, a microcontroller, a microprocessor, a CPU, a GPU, an auxiliary processing unit, a FPGA, or the like.

The method 1500 may comprise 1502 transmitting configured grant uplink transmission configuration including uplink transmission resources; and 1504 monitoring a WUS (wake up signal) a first duration before every one or multiple uplink transmission resources or a wake-up period. The first duration may be configured by higher layer signaling.

In some embodiment, when the WUS is detected the first duration before one or multiple uplink transmission resources or the wake-up period, the method further comprises monitoring subsequent one or multiple configured granted resource(s) for uplink data.

In one embodiment, the frequency position of the WUS is determined by a frequency offset to the uplink transmission resources. In another embodiment, the time duration and/or the frequency band of the WUS is scaled from the uplink transmission resource.

In some embodiment, the number of the uplink transmission resources is determined by the WUS. In some other embodiment, the WUS is derived from an RS of the uplink transmission in the uplink transmission resource.

FIG. 16 is a schematic block diagram illustrating apparatuses according to one embodiment.

Referring to FIG. 16, the UE (i.e. the remote unit) includes a processor, a memory, and a transceiver. The processor implements a function, a process, and/or a method which are proposed in FIG. 12 or FIG. 14.

The UE may comprise a receiver that receives PRACH configuration, wherein one or multiple ROs are in a PRACH configuration period; and a transmitter that transmits at least a WUS (wake up signal) within a wake-up period, the WUS is transmitted at the first or first several ROs within the wake-up period, or at a resource in front of RO(s) within the wake-up period. The wake-up period may be one or multiple of the PRACH configuration period.

In some embodiment, the WUS is transmitted when random access is expected to be performed in ROs following to the resource at which the WUS is transmitted.

In one embodiment, the ROs within the wake-up period are associated with an SSB within an associated period in which the SSB and the ROs are associated, wherein the associated period is one or multiple of the PRACH configuration period, and the first or first several ROs within the wake-up period are first or first several ROs associated with the SSB in time domain. In particular, the first or first several ROs within the wake-up period are one or more ROs associated with the SSB having the highest or lowest frequency band(s) in frequency domain. In some embodiment, the wake-up period is a first number of the associated period. The first number may be configured by higher layer signaling.

In some embodiment, the WUS is selected from a WUS set, where the WUS set is a subset of a preamble set in PRACH procedure. In other embodiment, the WUS is selected from a WUS set associated with a UE group including the UE, where the WUS set associated with the UE group is a subset of preamble set in PRACH procedure.

The UE may alternatively comprise a receiver that receives configured grant uplink transmission configuration including uplink transmission resources; and a transmitter that transmits a WUS (wake up signal) a first duration before every one or multiple uplink transmission resources or a wake-up period. The first duration is configured by higher layer signaling. The first duration may be configured by higher layer signaling.

In some embodiment, the WUS is transmitted in the latest uplink resource no early than the first duration before every one or multiple uplink transmission resources or start of the wake-up period.

In one embodiment, the frequency position of the WUS is determined by a frequency offset to the uplink transmission resources. In another embodiment, the time duration and/or the frequency band of the WUS is scaled from the uplink transmission resource.

In some embodiment, the number of the uplink transmission resources is determined by the WUS. In some other embodiment, the WUS is derived from an RS of the uplink transmission in the uplink transmission resource.

Referring to FIG. 16, the gNB (i.e. base unit) includes a processor, a memory, and a transceiver. The processors implement a function, a process, and/or a method which are proposed in FIG. 13 or FIG. 15.

The base unit may comprise a transmitter that transmits PRACH configuration, wherein one or multiple ROs are in a PRACH configuration period; and a processor that monitors a WUS (wake up signal) at the first or first several ROs within the wake-up period, or at a resource in front of RO(s) within the wake-up period. The wake-up period may be one or multiple of the PRACH configuration period.

In some embodiment, when the WUS is detected at any of the first or first several ROs within the wake-up period or at the resource in front of RO(s) within the wake-up period, the processor further monitors the following ROs for normal random access.

In one embodiment, the ROs within the wake-up period are associated with an SSB within an associated period in which the SSB and the ROs are associated, wherein the associated period is one or multiple of the PRACH configuration period, and the first or first several ROs within the wake-up period are first or first several ROs associated with the SSB in time domain. In particular, the first or first several ROs within the wake-up period are one or more ROs associated with the SSB having the highest or lowest frequency band(s) in frequency domain. In some embodiment, the wake-up period is a first number of the associated period. The first number may be configured by higher layer signaling.

In some embodiment, the WUS is selected from a WUS set, where the WUS set is a subset of a preamble set in PRACH procedure. In other embodiment, the WUS is selected from a WUS set associated with a UE group including the UE, where the WUS set associated with the UE group is a subset of preamble set in PRACH procedure.

The base unit may alternatively comprise a transmitter that transmits configured grant uplink transmission configuration including uplink transmission resources; and a processor that monitors a WUS (wake up signal) a first duration before every one or multiple uplink transmission resources or a wake-up period. The first duration is configured by higher layer signaling. The first duration may be configured by higher layer signaling.

In some embodiment, when the WUS is detected the first duration before one or multiple uplink transmission resources or the wake-up period, the processor further monitors subsequent one or multiple configured granted resource(s) for uplink data.

In one embodiment, the frequency position of the WUS is determined by a frequency offset to the uplink transmission resources. In another embodiment, the time duration and/or the frequency band of the WUS is scaled from the uplink transmission resource.

In some embodiment, the number of the uplink transmission resources is determined by the WUS. In some other embodiment, the WUS is derived from an RS of the uplink transmission in the uplink transmission resource.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A method performed by a user equipment (UE), the method comprising:
receiving Physical Random Access Channel (PRACH) configuration, wherein one or multiple RACH Occasions (ROs) are in a PRACH configuration period; and
transmitting at least a WUS (wake up signal) within a wake-up period, the WUS transmitted at the first or first several ROs within the wake-up period or at a resource in front of RO(s) within the wake-up period.

2. The method of claim 1, wherein, the wake-up period is one or multiple of the PRACH configuration period.

3. The method of claim 1, wherein, the WUS is transmitted when random access is expected to be performed in ROs following the resource at which the WUS is transmitted.

4. The method of claim 1, wherein:
the ROs within the wake-up period are associated with a Synchronization Signal Block (SSB) within an associated period in which the SSB and the ROs are associated, wherein the associated period is one or multiple of the PRACH configuration period; and
the first or first several ROs within the wake-up period are a first or first several ROs associated with the SSB in time domain.

5. The method of claim 4, wherein the first or first several ROs within the wake-up period are one or more ROs associated with the SSB having highest or lowest frequency band(s) in frequency domain.

6. The method of claim 4, wherein the wake-up period is a first number of the associated period.

7. The method of claim 6, wherein the first number is configured by higher layer signaling.

8. The method of claim 1, wherein the WUS is selected from a WUS set, where the WUS set is a subset of a preamble set in PRACH procedure.

9. The method of claim 1, wherein the WUS is selected from a WUS set associated with a UE group including the UE, where the WUS set associated with the UE group is a subset of preamble set in PRACH procedure.

10. (canceled)

11. A method performed by a base unit, the method comprising:
transmitting PRACH configuration, wherein one or multiple ROs are in a PRACH configuration period; and
monitoring for a WUS (wake up signal) at a first or first several ROs within the wake-up period or at a resource in front of RO(s) within the wake-up period.

12. The method of claim 11, further comprising: when the WUS is detected at any of the first or first several ROs within the wake-up period or at the resource in front of RO(s) within the wake-up period, monitoring following ROs for normal random access.

13. A base unit, comprising:
a transmitter that transmits PRACH configuration, wherein one or multiple ROs are in a PRACH configuration period; and
a processor that monitors a WUS (wake up signal) at the first or first several ROs within the wake-up period or at a resource in front of RO(s) within the wake-up period.

14. The base unit of claim 13, wherein the processor further monitors following ROs for normal random access when the WUS is detected at any of the first or first several ROs within the wake-up period or at the resource in front of RO(s) within the wake-up period.

15. A UE comprising:
a receiver that receives PRACH configuration, wherein one or multiple ROs are in a PRACH configuration period; and
a transmitter that transmits at least a WUS (wake up signal) within a wake-up period, the WUS transmitted at a first or first several ROs within the wake-up period or at a resource in front of RO(s) within the wake-up period.

16. The UE of claim 15, wherein:
the ROs within the wake-up period are associated with a Synchronization Signal Block (SSB) within an associated period in which the SSB and the ROs are associated, wherein the associated period is one or multiple of the PRACH configuration period; and
the first or first several ROs within the wake-up period are a first or first several ROs associated with the SSB in time domain.

17. The UE of claim 16, wherein the first or first several ROs within the wake-up period are one or more ROs associated with the SSB having highest or lowest frequency band(s) in frequency domain.

18. The UE of claim 15, wherein the wake-up period is a first number of the associated period and the first number is configured by higher layer signaling.

19. The UE of claim 15, further comprising a processor that transmits the WUS, via the transmitter, when random access is expected to be performed in ROs following the resource at which the WUS is transmitted.

20. The UE of claim 19, wherein the processor selects the WUS from a WUS set, where the WUS set is a subset of a preamble set in PRACH procedure.

21. The UE of claim 19, wherein the processor selects the WUS from a WUS set associated with a UE group including the UE, where the WUS set associated with the UE group is a subset of preamble set in PRACH procedure.
